(19) United States
(12) Patent Application Publication
(10) Pub. No.: US 2007/0144122 A1
(43) Pub. Date: Jun. 28, 2007

(54) Air cleaner

(76) Inventor: James Ho, Taipei (TW)

Correspondence Address: LOWE HAUPTMAN BERNER, LLP, 1700 DIAGONAL ROAD, SUITE 300, ALEXANDRIA, VA, 22314, US

(21) Appl. No.: 11/316,881

(22) Filed: Dec. 27, 2005

(51) Int. Cl. B01D 46/00

(52) U.S. Cl. 55/471

(57) ABSTRACT

An air cleaner includes a housing having an air inlet and an air outlet, a casing mounted inside the housing and holding a first filter element with wire gauzes and a second filter element with active carbons at different elevations for removing solid matters and germs from currents of air passing from the air inlet toward the air outlet, two electric fans mounted on two ends of the casing for drawing currents of air into the inside of the housing through the air inlet toward the air outlet, a negative ion generator and an ultraviolet lamp mounted inside the housing for sterilizing currents of air passing through the housing.

### BACKGROUND OF THE INVENTION

1. Field of the Invention

The present invention relates air cleaners and more particularly, to such an air cleaner, which uses multiple air filter elements to remove solid matters and germs from air, preventing adhering of dust to the internal electric fans.

2. Description of the Related Art

Induced-draft fans are commonly used to carry spoil indoor air out of the house and heat energy away from electric apparatus. An induced-draft fan generally comprises a casing, a fan blade suspending inside the casing, and a fan motor mounted inside the casing and adapted to rotate the fan blade. When electrically connected, the fan motor is started to rotate the fan blade, thereby inducing currents of air to draw indoor air out of the house or outdoor fresh air into the inside of the house. An induced-draft fan can only induce currents of air. It cannot remove dust or germs from air.

In order to clean the air, an air cleaner shall be used. A regular air cleaner generally has a wire gauze filter mounted in the air outlet to remove dust from output air. The use of such a wire gauze filter in the air outlet cannot prohibit adherence of dust to the electric fan inside the air cleaner. When the shaft, fan blade or other movable parts of the electric fan of an air cleaner are covered with dust, the movable parts of the electric fan may unable to move or may produce a high noise during movement.

Therefore, it is desirable to provide an air cleaner that eliminates the aforesaid problems.

### SUMMARY OF THE INVENTION

The present invention has been accomplished under the circumstances in view. According to one aspect of the present invention, the air cleaner comprises a housing, which has an air inlet and an air outlet disposed at two opposite sides, at least one electric fan respectively mounted inside the housing and adapted to draw currents of air into the inside of the housing through the air inlet toward the air outlet, a first filer element mounted in the air inlet and having at least one wire gauze adapted to remove solid matters from currents of air that flow through the air inlet toward the air outlet, and a second filter element mounted in the housing between the first filter element and the at least one electric fan and carrying active carbons for removing germs from currents of air passing through the first filter element toward the air outlet.

According to another aspect of the present invention, the housing is made out of aluminum that dissipates heat from the at least one electric fan into the outside air efficiently.

According to still another aspect of the present invention, a sound absorbing material is mounted around the inside wall of the housing to absorb noises produced during operation of the at least one electric fan. The sound absorbing material provides an effect equivalent to a 8mm sound deadening glass.

According to still another aspect of the present invention, louvers are mounted in the housing for controlling the opening of the air inlet and stopping outside moisture from entering the housing.

According to still another aspect of the present invention, a negative ion generator and an ultraviolet lamp are respectively mounted inside the housing to generate negative ions and to emit ultraviolet light respectively, thereby sterilizing the air.

### BRIEF DESCRIPTION OF THE DRAWINGS

FIG. 1 is an oblique front elevation of an air cleaner according to the present invention.

FIG. 2 is an oblique rear elevation of the air cleaner according to the present invention.

FIG. 3 is an exploded view of a part of the present invention, showing the internal structure of the air cleaner.

FIG. 4 is a schematic sectional view of the present invention, showing the air cleaner in action.

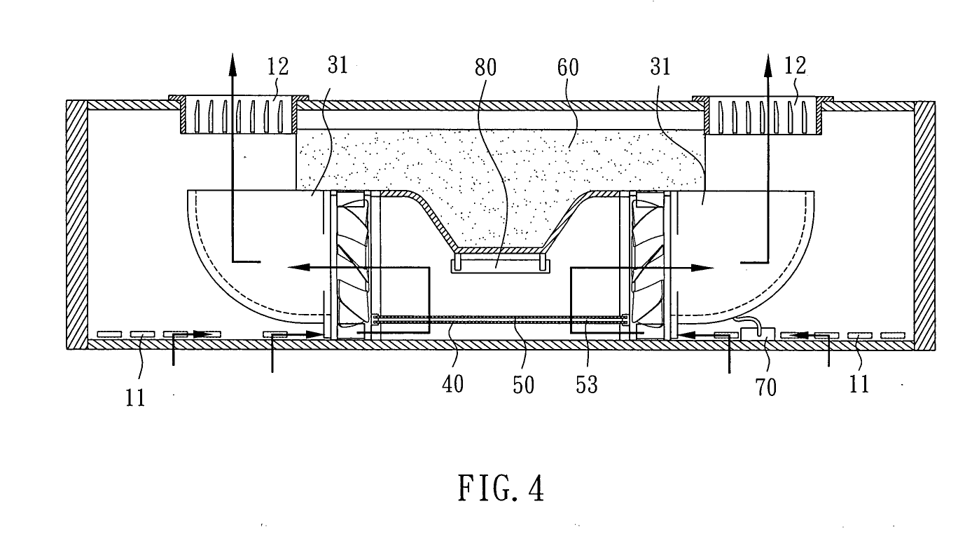

FIG. 5 is a schematic perspective view of the present invention, showing the air cleaner in action.

### DETAILED DESCRIPTION OF THE PREFERRED EMBODIMENT

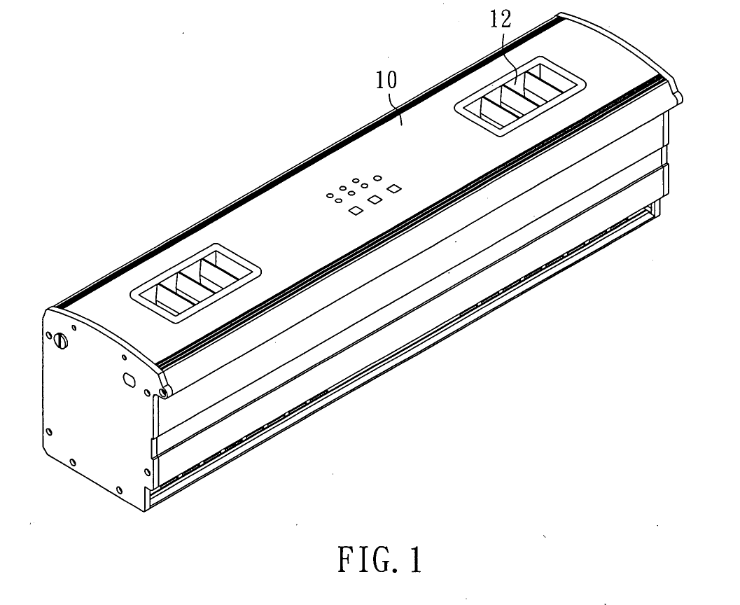

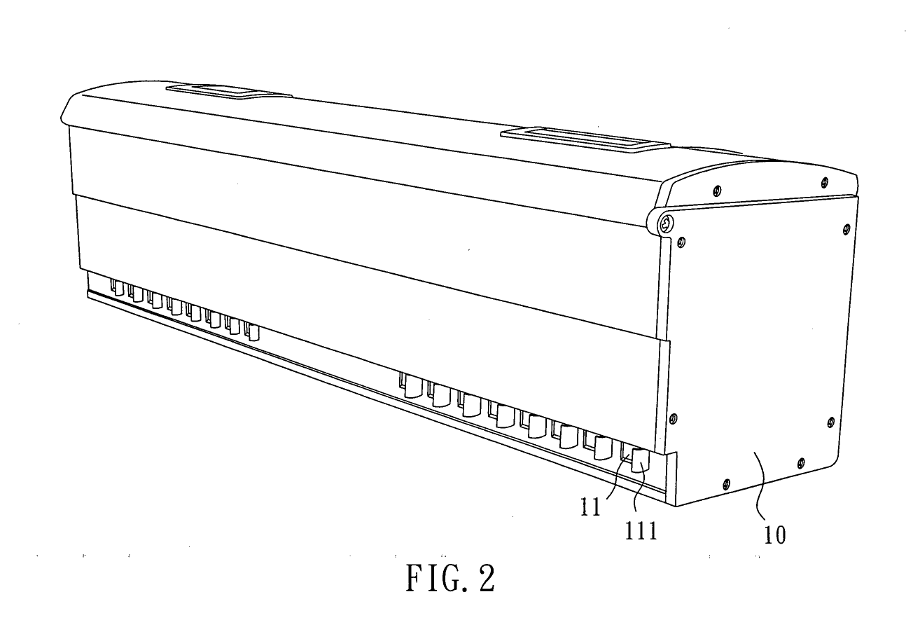

Referring to FIG. 1˜3, an air cleaner in accordance with the present invention is shown comprising a housing 10. According to the present preferred embodiment, the housing 10 is a rectangular case made out of metal, for example, aluminum, iron, or stainless steel. The housing 10 has an air inlet 11 (see FIG. 2) and an air outlet 12 (see FIG. 1) for letting air pass in and out of the housing 10, and louvers 111 adapted to close/open the air inlet 11 (see FIG. 2).

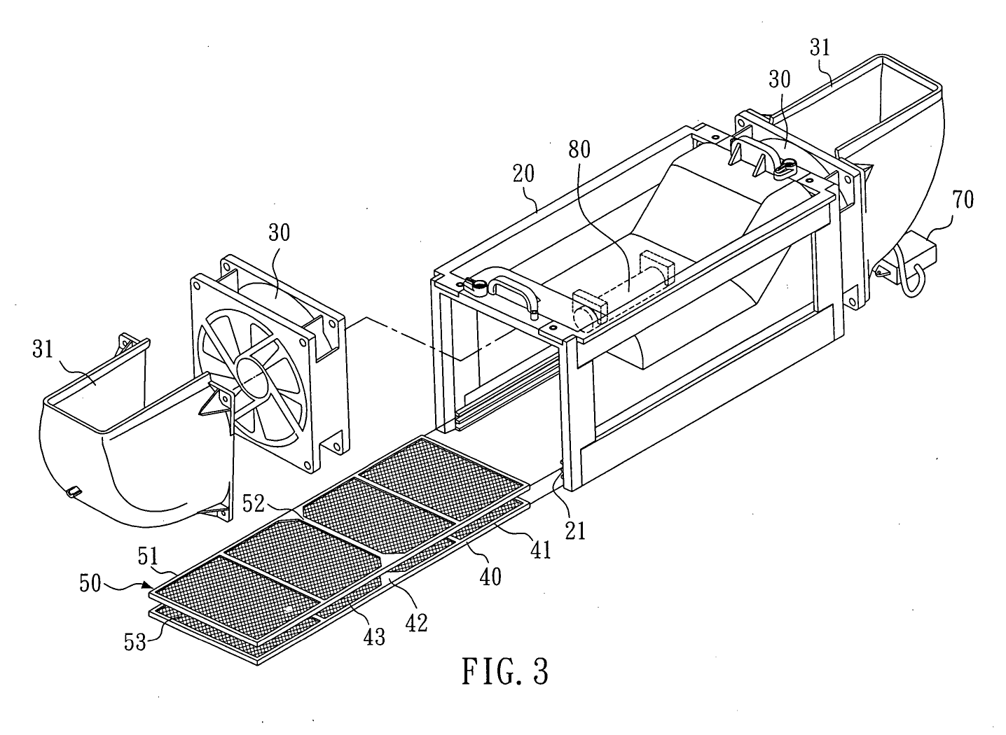

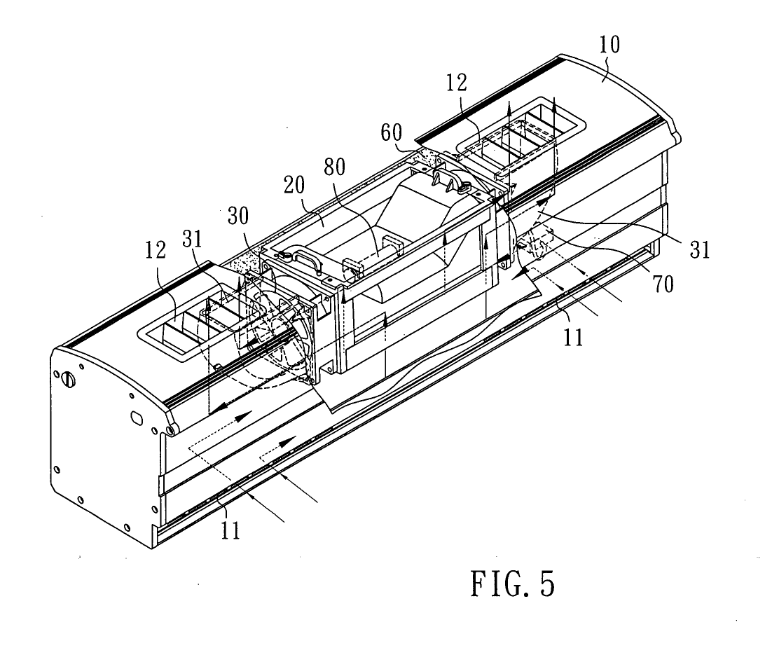

Further, a casing 20 is mounted inside the housing 10 and fixedly secured to the inside wall of the housing 10 by screws (see FIG. 5). As shown in FIGS. 3 and 5, the casing 20 has coupling grooves 21 bilaterally arranged in parallel at the bottom open side thereof at different elevation adapted to hold a first filter element 40 and a second filter element 50 corresponding to the air inlet 11 of the housing 10. The first filter element 40 is disposed in proximity to the air inlet 11 of the housing 10, comprising a rectangular filter frame 41, a plurality of partition ribs 42 connected between two opposite sides of the rectangular filter frame 41 and dividing the holding area of the rectangular filter frame 41 into separated open spaces, and wire gauzes 43 respectively suspended in the open spaces within the rectangular filter frame 41. The second filter element 50 is spaced above the first filter element 40, comprising a rectangular filter frame 51, a plurality of partition ribs 52 connected between two opposite sides of the rectangular filter frame 51 and dividing the holding area of the rectangular filter frame 51 into separated open spaces 53 which are mounted with filter sponges, active carbons, or sterilizing materials (see FIG. 3).

Further, two electric fans 30 are respectively affixed to the two distal ends of the casing 20. Two air ducts 31 are respectively coupled to the electric fans 30 and adapted to guide currents of air from the electric fans 30 to the air outlet 12 of the housing 10. The first filter element 40 removes solid matters from the currents of air that are drawn by the electric fans 30 and flow through the air inlet 11 into the inside of the casing 20. The second filter element 50 removes germs from the currents of air that are filtered through the first filter element 40. The air ducts 31 guide the well-filtered intake flow of air to the outside of the housing 10 through the air outlet 12. Therefore, the air cleaner supplies fresh clean air.

Further, a negative ion generator 70 and an UV (Ultraviolet) lamp 80 are mounted inside the casing 20. The negative ion generator 70 generates negative ions to remove dust from air passing through the casing 20 toward the air ducts 31 and the air outlet 12. The UV lamp 80 emits ultraviolet light to kill germs.

Further, a sound absorbing member 60, for example, a sound absorbing sponge is sandwiched between the outside wall of the casing 20 and the inside wall of the housing 10 to absorb sound, preventing noises.

Referring to FIGS. 3˜5 and FIG. 1, when in use, the electric fans 30 are started to draw currents of air through the air inlet 11 into the inside of the housing 10. At this time, the louvers 111 are set in a tilting position to stop outside moisture from entering the air inlet 11. The currents of air that flow through the air inlet 11 into the inside of the housing 10 are filtered by the first filter element 40 and the second filter element 50, preventing adhering of dust to the electric fans 30. By means of the effect of the electric fans 30 and the effect of the air dusts 31, the intake currents of air are guided out of the housing 10 through the air outlet 12 via the negative ion generator 70 and the UV lamp 80. Therefore, cleaned and sterilized currents of air are supplied to the desired space area. Further, because the housing 10 is made out of aluminum, the heat energy produced during operation of the electric fans 30 can be quickly dissipated out of the air cleaner.

Although a particular embodiment of the invention has been described in detail for purposes of illustration, various modifications and enhancements may be made without departing from the spirit and scope of the invention.

What the invention claimed is:

1. An air cleaner comprising:
a housing, said housing having an air inlet and an air outlet disposed at two opposite sides;
at least one electric fan respectively mounted inside said housing and adapted to draw currents of air into the inside of said housing through said air inlet toward said air outlet;
a first filer element mounted in said air inlet, said first filter element comprising at least one wire gauze adapted to remove solid matters from currents of air that flow through said air inlet toward said air outlet; and
a second filter element mounted in said housing between said first filter element and said at least one electric fan, said second filter element comprising active carbons adapted to remove germs from currents of air passing through said first filter element toward said air outlet.

2. The air cleaner as claimed in claim 1, further comprising a casing fixedly mounted inside said housing, said casing comprising parallel coupling grooves corresponding to said air inlet of said housing; said at least one electric fan includes two electric fans respectively mounted on two opposite sides of said casing; said first filter element and said second filter element are respectively coupled to the parallel coupling grooves of said casing.

3. The air cleaner as claimed in claim 1, wherein said at least one electric fan each is mounted with an air duct adapted to guide currents of air from said air inlet toward said air outlet.

4. The air cleaner as claimed in claim 1, wherein said housing is made out of aluminum.

5. The air cleaner as claimed in claim 1, further comprising a sound absorbing material mounted around an inside wall of said housing.

6. The air cleaner as claimed in claim 5, wherein said sound absorbing material is a sound absorbing sponge.

7. The air cleaner as claimed in claim 1, wherein said housing comprises a plurality of louvers adapted to close/open said air inlet.

8. The air cleaner as claimed in claim 1, further comprising a negative ion generator mounted inside said housing.

9. The air cleaner as claimed in claim 1, further comprising an ultraviolet lamp mounted inside said housing.
